(19) United States
(12) Patent Application Publication
(10) Pub. No.: US 2014/0114770 A1
(43) Pub. Date: Apr. 24, 2014

(54) ONLINE TECHNIQUES FOR PROVIDING OFFERS BASED ON SOCIAL ACTIVITY

(71) Applicant: YAHOO! INC., Sunnyvale, CA (US)

(72) Inventor: Supreeth Hosur Nagesh Rao, Sunnyvale, CA (US)

(73) Assignee: YAHOO! INC., Sunnyvale, CA (US)

(21) Appl. No.: 13/655,244

(22) Filed: Oct. 18, 2012

(51) Int. Cl. G06Q 30/02

(52) U.S. Cl. 705/14.66

(57) ABSTRACT

Techniques for providing offers for products/services associated with a topic to users based on a measure of conversion determined for the users are described. The measure of conversion for each user may be indicative of a probability that the user will purchase item(s) associated with a particular topic. The measure of conversion may be based on social activity associated with the user and social activity associated with other users that have formed a social connection with the user. Offers associated with the particular topic are presented to the user in response to determining that the measure of conversion of the user for the topic reaches a predetermined threshold and/or matches further criteria.

### BACKGROUND OF THE INVENTION

1. Field of the Invention

The present invention relates to online deals and incentives.

2. Background

For many years, customers have been able to shop for products and services. Traditionally, a customer has been able to purchase a product or service from a merchant. The merchant may occasionally offer discounts on their products and/or services. Such discounts may benefit customers with lower prices, and may benefit merchants by enabling increased sales volumes, enabling excess inventory to be reduced, and providing further benefits.

In recent years, the Internet has provided a new medium for customers to purchase products and services from merchants. For example, thousands of electronic commerce websites, such as amazon.com, provided by Amazon.com, Inc. of Seattle, Wash., and ebay.com, provided by eBay Inc. of San Jose, Calif., have been established that sell products and services over the Internet. The availability of products and services for sale over the Internet has made shopping more convenient for customers and enabled merchants to reach larger numbers of customers.

Some websites have recently been provided online that provide coupons for discounted products and services to groups of users. Examples of such websites include www.groupon.com provided by Groupon, Inc. of Chicago, Ill. and livingsocial.com provided by LivingSocial Inc. of Washington, D.C. Some of these websites provide coupons that are activated if a predetermined minimum number of persons sign up for a particular deal. For instance, a discounted price for a single product or service may be offered to users. If a predetermined number of the users sign up for the offer, then the deal becomes available to all of the users. If the predetermined number of the users does not sign up for the offer, the offer is retracted and is not available to any of the users.

One drawback to the ever-increasing number of coupons being offered via the Internet, however, is that consumers are becoming overwhelmed. Consumers are increasingly being bombarded by coupons that are not useful or attractive to the user due to poor targeting schemes. As such, consumers are more likely to ignore coupon offers presented to them, and therefore, miss out on coupons that the consumers actually might find useful or attractive.

### BRIEF SUMMARY OF THE INVENTION

Various approaches are described herein for, among other things, providing offers for products/services (“items”) associated with a topic to user(s) based on a measure of conversion determined for the user(s). The measure of conversion for each user may be indicative of a probability that the user will purchase item(s) associated with a particular topic. The measure of conversion may be based on social activity associated with the user and social activity associated with other users that have formed a social connection with the user. Offers associated with the particular topic are presented to the user in response to determining that the measure of conversion of the user for the topic reaches a predetermined threshold and/or meets other criteria.

In one method implementation, offer(s) are presented to a user by, for each of a plurality of topics, determining a measure of influence that social activity has on the user for the topic, determining a measure of interest of the user for the topic, and determining a measure of conversion of the user for the topic. The measure of conversion is determined based on the measure of influence and the measure of interest. The measure of conversion is indicative of a probability that the user will purchase an offer associated with the topic.

For one of the plurality of topics, the offer(s) are presented by determining whether the measure of conversion reaches a predetermined threshold, and presenting offer(s) associated with the topic in response to determining that the measure of conversion reaches the predetermined threshold and/or meets other criteria.

In one system implementation, a system for presenting offer(s) to a user includes an influence determiner, an interest determiner, a conversion determiner, a threshold determiner, and an offer provider. The influence determiner is configured to, for each of a plurality of topics, determine a measure of influence that social activity has on a user for the topic. The interest determiner is configured to, for each of the plurality of topics, determine a measure of interest of the user for the topic. The conversion determiner is configured to, for each of the plurality of topics, determine a measure of conversion of the user for the topic. The measure of conversion is indicative of a probability that the user will purchase an offer associated with the topic and is based on the measure of influence and the measure of interest. The threshold determiner is configured to, for one of the plurality of topics, determine whether the measure of conversion reaches a predetermined threshold and/or meets other criteria. The offer provider is configured to present offer(s) associated with the topic in response to a determination that the measure of conversion reaches the predetermined threshold and/or meets the other criteria.

Computer program products containing computer readable storage media are also described herein that store computer code/instructions for enabling offer(s) to be provided to user(s), as well as enabling further embodiments described herein.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 shows a block diagram of a communication system for presenting offers based on social activity, according to an example embodiment.

FIG. 2 shows a flowchart providing a process for presenting offers based on social activity, according to an example embodiment.

FIG. 3 shows a block diagram of a deal conversion system, according to an example embodiment.

FIG. 4 shows a flowchart providing a process for determining a measure of influence that social activity has on a user for a topic, according to an example embodiment.

FIG. 5 shows a block diagram of an influence determiner, according to an example embodiment.

FIG. 6 shows a process for determining a measure of interest of a user for a topic, according to an example embodiment.

FIG. 7 shows a block diagram of an interest determiner, according to an example embodiment.

FIG. 8 is a block diagram of a computing device in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Websites exist that provide coupons for discounted products and services, such as groupon.com and livingsocial.com. Some of these websites provide coupons that are activated if a predetermined minimum number of persons sign up for a particular deal (e.g., a “Groupon®”). For instance, a company may offer a discounted price for a single product or service to users. The offer may be made to the users by email or by other communication. If a predetermined number of the users sign up for the offer, then the deal becomes available to all of the users. If the predetermined number of the users does not sign up for the offer, the offer is retracted from all of the users.

However, such techniques for providing coupons have limitations, such as not taking into account social activity associated with the user for whom the coupons are provided. Furthermore, such techniques do not take into account social activity of other users that have a social connection with the user. As such, such techniques do not take advantage of the effect that social influence has over purchase making decisions made by the user.

In embodiments, improved techniques are provided for online shopping using coupons, discounts, and further types of commercial incentives. In an embodiment, an online shopping system is provided that provides offer(s) to user(s) based on a measure of conversion determined for the user(s). The measure of conversion for each user may be indicative of a probability that the user will purchase item(s) associated with a particular topic. The measure of conversion may be based on social activity associated with the user and social activity associated with other users that have formed a social connection with the user. Embodiments provide improvements over such shopping techniques, such that merchants are able to provide offer(s) that a user is likely to accept or purchase by exploiting the effect that social influence has over purchase making decisions made by the user.

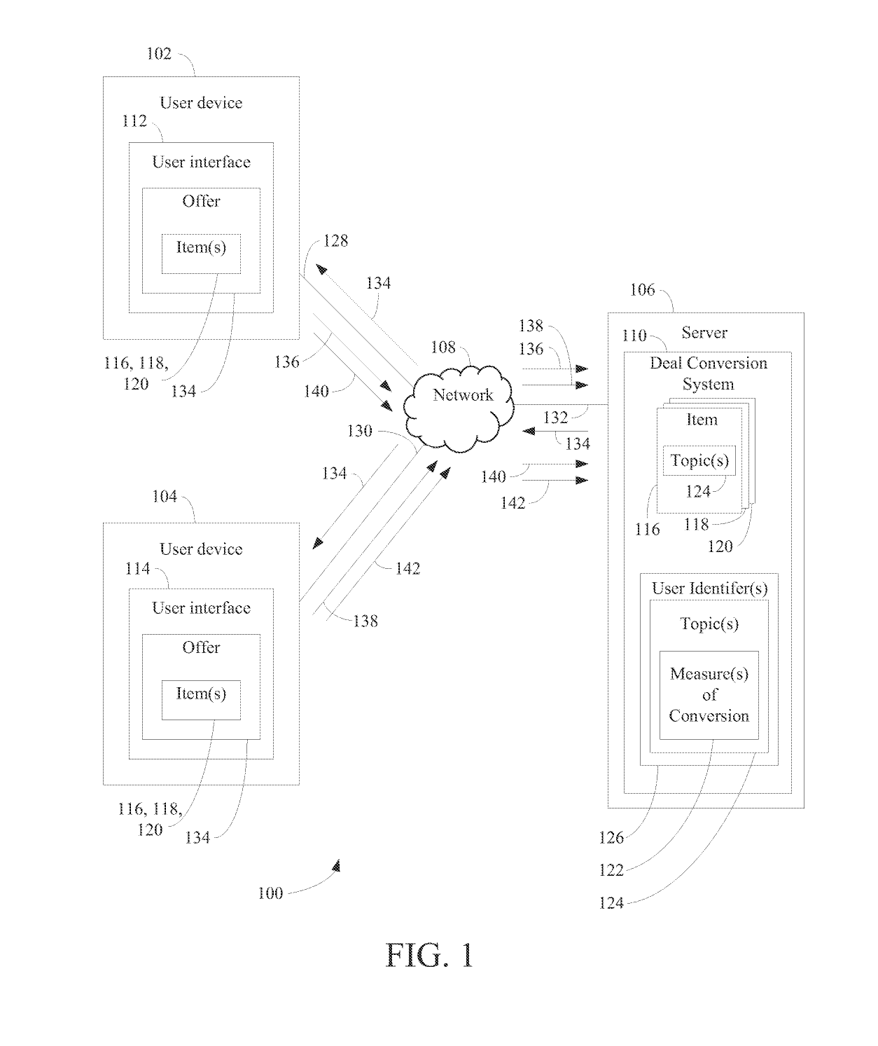

Such embodiments may be implemented in a variety of environments. For instance, FIG. 1 shows a block diagram of a communication system 100 in which offers are presented based on social activity, according to an example embodiment. System 100 is shown for purposes of illustration, and embodiments may be implemented in other environments, as would be apparent to persons skilled in the relevant art(s) from the teachings herein. As shown in FIG. 1, system 100 includes first and second user devices 102 and 104, a server 106, and network 108. Furthermore, server 106 includes a deal conversion system 110. System 100 is described as follows.

User devices 102 and 104 may each be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a smart phone (e.g., an Apple iPhone, a Google Android™ phone, a Microsoft Windows® phone, etc.), or other type of computing device. Server 106 may be implemented in one or more computer systems, including one or more servers, which may be any type of computing device described herein or otherwise known that is capable of enabling the corresponding functionality described herein.

User devices 102 and 104 and server 106 are communicatively coupled with each other through network 108. Network 108 may be a LAN (local area network), a WAN (wide area network), or any combination of networks, such as the Internet. User devices 102 and 104 are each coupled with network 108 through a corresponding one of communication links 128 and 130, and server 106 is coupled with network 108 by communication link 132. Communication links 128, 130, and 132 may each include wired and/or wireless links. Examples of communication links 128, 130, and 132 include IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB (universal serial bus) links, etc.

Although two user devices 102 and 104 and one server 106 are depicted in FIG. 1, persons skilled in the relevant art(s) will recognize that any number of user devices may be communicatively coupled among any number of servers via any number of communication links.

Deal conversion system 110 is configured to determine a measure of conversion 122 (also referred to as a “conversion indication”) of a user for a plurality of topics. A plurality of such measures of conversion may be generated for each user, and each measure of conversion generated for a user is indicative of a probability that the user will purchase products and/or services (“items”) of a particular topic that may be offered to the user. For example, as shown in FIG. 1, deal conversion system 110 may determine measure(s) of conversion 122 of each of users 102 and 104 (and for further users) for each of topic(s) 124. Deal conversion system 110 associates measure(s) of conversion 122 with each user 102 and 104 using user identifier(s) 126. Although measure(s) of conversion 122 and user identifier(s) 126 are depicted in FIG. 1 as being stored on server 106, persons skilled in the relevant art(s) will recognize that measure(s) of conversion 122 and user identifier(s) 126 may be stored remotely in a storage device communicatively coupled to server 106.

Each measure of conversion 122 of a user may be based on a measure of influence that social activity has on the user for a particular topic. The measure of influence may be based on one or more social activities associated with the particular topic that is/are performed by other user(s) that have a social connection with the user. Examples of social activit(ies) performed by the other user(s) include, but are not limited to, sending e-mail(s) directed to the particular topic to the user, sending instant messaging (IM) text messages directed to the particular topic to the user, posting a social networking message (or causing a social networking message to be posted) on the user's profile page associated with a social networking website, “like” indications that indicate a product and/or service associated with the particular topic are liked via a social networking website, posting a microblog message (e.g., a “tweet” provided by Twitter, Inc. of San Francisco, Calif.) on the user's profile page associated with a microblogging service, and/or the like. Examples of social networks include Facebook® operated by Facebook, Inc. of Palo Alto, Calif., Google+ operated by Google, Inc. of Mountain View, Calif., etc. Examples of microblogging services include Twitter® operated by Twitter, Inc. of San Francisco, Calif. and Tumblr® operated by Tumblr, Inc. of New York City, N.Y., etc. Examples of a social connection between users include, but are not limited to, becoming “friends” via a social networking website, user(s) “following” other user(s) via a microblogging service, and/or the like.

The measure of influence may further be based on a distance between the user and the other user(s). In one embodiment, the distance is determined by a level of interaction that the user has with the other user(s). In accordance with this embodiment, a first user that has a relatively greater level of interaction with the user than a second user is designated as being a shorter distance to the user than the second user. Examples of interaction include, but are not limited to, e-mail messages transmitted between the user and the other user(s), IM text messages transmitted between the user and the other user(s), social network postings made between the user and the other user(s), “like” indications performed by the user on social network postings made by the other user(s) and vice versa, and/or the like. In another embodiment, the distance between the user and other user(s) may be determined by how the user socially classifies the other user(s). For example, user(s) having a social classification of a first type (e.g., family members, close friends, etc.) may be designated as being a shorter distance to the user than user(s) having a social classification of a second type (e.g., co-workers, friends of friends, etc.).

Each measure of conversion 122 for a particular user may be further based on a measure of interest of the user for the particular topic. The measure of interest may be based on the social activities associated with the particular topic that are performed by the user and the frequency at which the social activities are performed by the user.

As shown in FIG. 1, one or more user devices 102 and 104 may transmit an indication, such as social activity indications 136 and 138, for each social activity performed via user device(s) 102 and 104 to server 106. Indications 136 and 138 may indicate social activity performed by the user for which the measure of conversion is being determined and social activity performed by other user(s) that have a social connection with the user. As such, each of indications 136 and 138 may indicate the user, an activity, and another user that engaged with the user in the activity. Any number of such indications may be received. Server 106 may receive and track indications 136 and 138, and deal conversion system 110 determines the measure of influence, the measure of interest, and the measure of conversion for the user using indications 136 and 138. It is noted that indications 136 and 138 (and potentially further indications) may alternatively be generated and transmitted to server 106 from other sources through network 108, such as from social network servers, from email servers, text messaging servers, and/or other sources where social activity takes place and/or is tracked.

For any given topic 124, deal conversion system 110 may determine whether measure of conversion 122 for the user reaches a predetermined threshold and/or meets other criteria. In response to determining that measure of conversion 122 reaches the predetermined threshold (or meets the other criteria), one or more offers 134 associated with topic 124 may be presented to the user.

As shown in FIG. 1, deal conversion system 110 at server 106 may transmit offer(s) 134 for item(s) 116, 118 and 120 associated with topic 124 to one or more users. The offer(s) may be for item(s) 116, 118, and 120 at discounted prices. The offer(s) 134 transmitted to a user may be based on the user's measure of conversion for topic 124. For instance, deal conversion system 110 may determine whether measure of conversion 122 for topic 124 reaches a predetermined threshold for a user. In response to determining that measure of conversion 122 for topic 124 reaches the predetermined threshold, deal conversion system 110 may present offer(s) 134 associated with topic 124 to the user. In response to determining that measure of conversion 124 for a particular topic 124 does not reach the predetermined threshold, deal conversion system 110 may not present offer(s) 134 associated with topic 124 to the user.

Offer(s) 134 may be transmitted in one or more communication signals through network 108 to users at user devices 102 and 104. For instance, offer(s) 134 may be transmitted in one or more email messages, text messages, microblog messages, in social networking messages, web pages, messages displayed by an application (e.g., by an application executing in a desktop computer, a web application hosted in a browser, an “app” at a mobile device, etc.), or in another manner.

As shown in FIG. 1, offer(s) 134 are received for display to users at user devices 102 and 104. Users of user devices 102 and 104 form a user population. For instance, the user population may include users that are members of a deal offering service (e.g., an online coupon system, etc.) associated with deal conversion system 110, and/or may include users that are not members. User devices 102 and 104 may each include a corresponding one of user interfaces 112 and 114 that are used to provide (e.g., display) offer(s) 134 to one or more users. For instance, user interfaces 112 and 114 may each include a graphical user interface (GUI), such as a user interface provided by an email tool, by an application, by a web browser, etc. User interfaces 112 and 114 enable offer(s) 134 to be displayed to the users of user devices 102 and 104. The display of offer(s) 134 at user devices 102 and 104 includes an indication of item(s) 116, 118, and 120 and/or further information of offer(s) 134.

The users at user devices 102 and 104 may each accept or reject offer(s) 134. For instance, to accept offer(s) 134, a user may offer to purchase at least one of item(s) 116, 118, and 120 indicated in offer(s) 134. As shown in FIG. 1, one or more of user devices 102 and 104 may transmit a response, such as responses 140 and 142, to deal conversion system 110 at server 106. The number of responses 140 and 142 may be the same or different from the number of users to which offer(s) 134 was/were extended. Responses 140 and 142 each indicate any of item(s) 116, 118, and 120 that a user at a corresponding one of user devices 102 and 104 requested to purchase.

In one embodiment, each offer 134 may have an associated minimum purchase number. In accordance with this embodiment, the minimum purchase number for each offer 134 has to be met for offer 134 to be confirmed (e.g., the number of users that purchase offer 134 must reach or exceed the associated minimum purchase number in order for offer 134 to be confirmed).

Deal conversion system 110 receives responses 140 and 142 and determines whether to confirm a deal with the responding users based on responses 140 and 142. For instance, deal conversion system 110 may determine whether the minimum purchase number thresholds for each of item(s) 116, 118, and 120 of offer(s) 134 is/are met. If the threshold is met, deal conversion system 110 may confirm the deal, and the responding users are enabled to receive any item(s) 116, 118, and 120 of offer(s) 134 that they requested to purchase at the corresponding discounted purchase price(s). If the threshold is not met, the offer is not confirmed, and the users cannot purchase item(s) 116, 118, and 120 of offer(s) 134 at the discounted price(s). Alternatively, a particular offer may not require a particular number of accepting users to be confirmed.

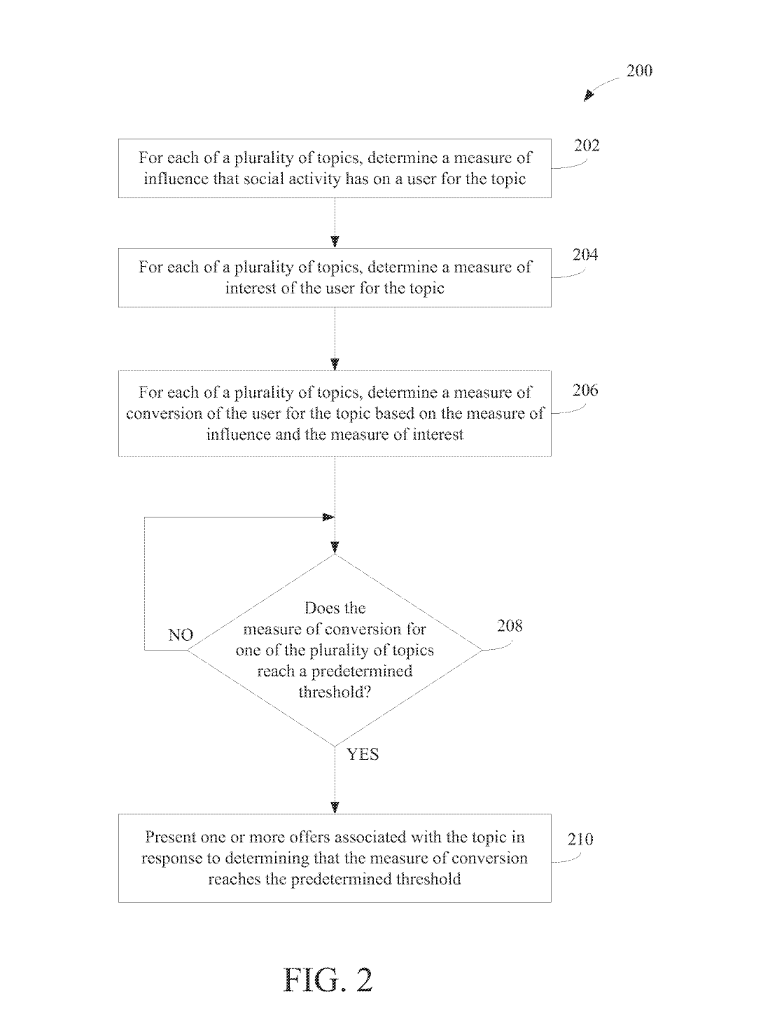

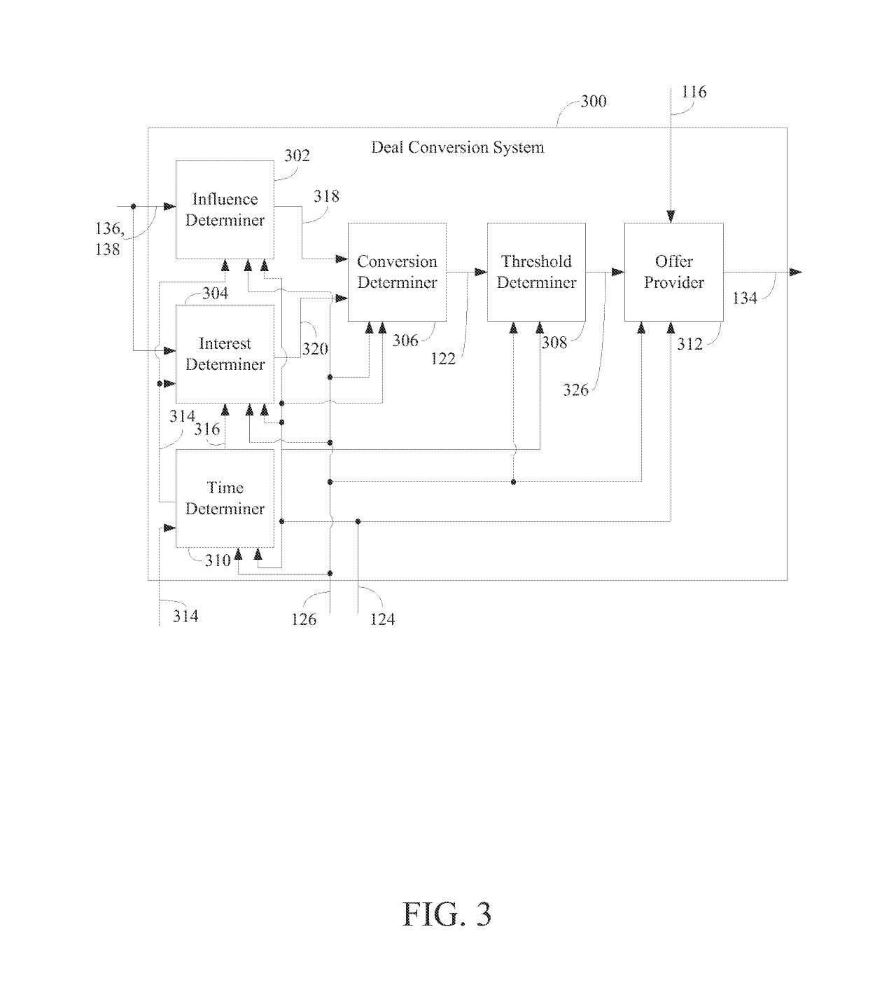

In embodiments, deal conversion system 110 may operate in various ways to provide offers to users based on social activity. For instance, FIG. 2 shows a flowchart 200 providing a process for presenting offers based on social activity, according to an example embodiment. In an embodiment, deal conversion system 110 may operate according to flowchart 200. Furthermore, FIG. 3 shows a block diagram of deal conversion system 300, according to an example embodiment. Deal conversion system 300 is an example of deal conversion system 110. As shown in FIG. 3, deal conversion system 300 includes an influence determiner 302, an interest determiner 304, a conversion determiner 306, a threshold determiner 308, a time determiner 310, and an offer provider 312. Flowchart 200 is described with respect to deal conversion system 300 for illustrative purposes. Further structural and operational embodiments will be apparent to persons skilled in the relevant art(s) based on the following description of flowchart 200 and deal conversion system 300.

Flowchart 200 begins with step 202. In step 202, for each of a plurality of topics, a measure of influence that social activity has on a user for the topic is determined. For example, in an embodiment, influence determiner 302 receives user identifier 126, topic 124, and indications 136 and 138. User identifier 126 and topic 124 respectively identify the user and topic for which a measure of conversion is being determined. Indications 136 and 138 received by influence determiner 302 may indicate social activity performed by other user(s) that have a social connection with the user. Influence determiner 302 may determine a measure of influence 318 for the user (identified via user identifier 126) based on indications 136 and 138 (and potentially further such indications) and transmits measure of influence 318 to conversion determiner 306.

Measure of influence 318 indicates an amount of influence that the social activity indicated by indications 136 and 138 (and potentially further such indications) has on the identified user for topic 124 is determined For instance, measure of influence 318 may be represented as follows:

measure of influence 318=g({a1×w1,f1,d1},{a2×w2,f2,d2} . . . )

where

g=a measure of influence function (e.g., an equation),

a1=a social activity performed by a second user that has a social connection with the identified user,

f1=a social contact identifier for the second user,
d1=a distance between the identified user and the second user,
a2=a social activity performed by a third user that has a social connection with the identified user,
f2=a social contact identifier for the third user, and
d2=a distance between the identified user and the third user.
   It is noted that according to the distance factor d, users who are social contacts at a shorter distance (e.g., user(s) that have a relatively greater level of interaction with the identified user than other user(s) and/or user(s) that are socially classified as being family members, close friends, etc.) can influence more, and thus may be weighted higher in the calculation of measure of influence 318. Users who are social contacts at a relatively further distance (e.g., user(s) that have a relatively lower level of interaction with the identified user than other user(s) and/or user(s) that are socially classified as being co-workers, friends of friends, etc.) may influence less, and thus may be weighted lower in the calculation of measure of influence 318.

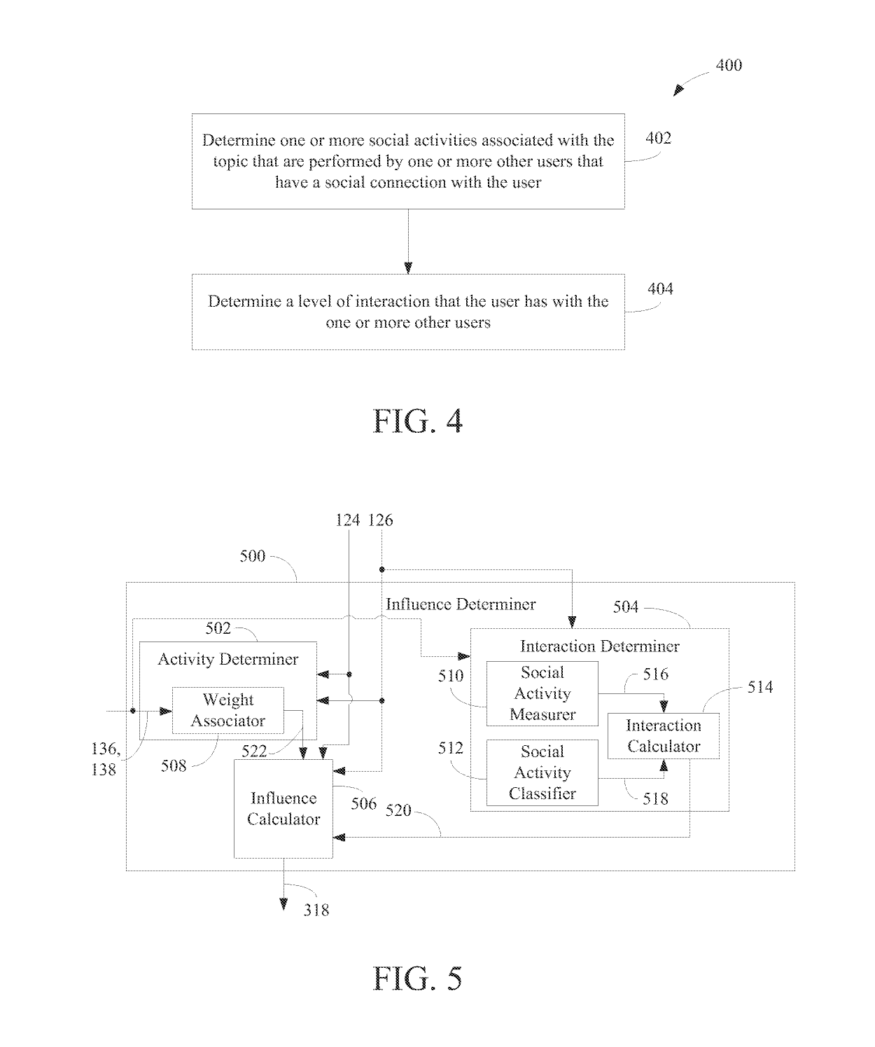

Measure of influence 318 may be represented in various ways, such as being represented by a numeric value, where a high numeric value indicates that the user is likely to be influenced by social activity for topic 124, and a low numeric value indicates that the user is not likely to be influenced by social activity with regard to topic 124. Additional details concerning the structure, function, and operation of influence determiner 302 is provided below in reference to FIGS. 4-5.

Referring back to FIG. 2, in step 204, for each of a plurality of topics, a measure of interest of the user for the topic is determined. For example, as shown in FIG. 3, in an embodiment, interest determiner 304 receives user identifier 126, topic 124, and indications 136 and 138. User identifier 126 and topic 124 respectively identify the user and topic for which the measure of interest is being determined. Indications 136 and 138 received by interest determiner 304 may indicate social activity performed by the user. Interest determiner 304 may determine a measure of interest 320 for the user (as identified via user identifier 126) based on indications 136 and 138 (and potentially further such indications) and transmits measure of interest 320 to conversion determiner 306.

Measure of interest 320 indicates an amount of interest the identified user has in topic 124 based on the social activity indicated by indications 136 and 138 (and potentially further such indications). For instance, measure of interest 320 may be represented for a particular topic as follows:

measure of interest 320=h(a1×freq1+a2×freq2 . . . )

where

h=a measure of interest function,

a1=a first social activity performed by the identified user within the topic,

freq1=a frequency of the first social activity a1 within the topic,

a2=a second social activity performed by the identified user within the topic, and

freq2=a frequency of the second social activity a2 within the topic.

As such, a value for measure of interest 320 may be generated for each topic for the user.

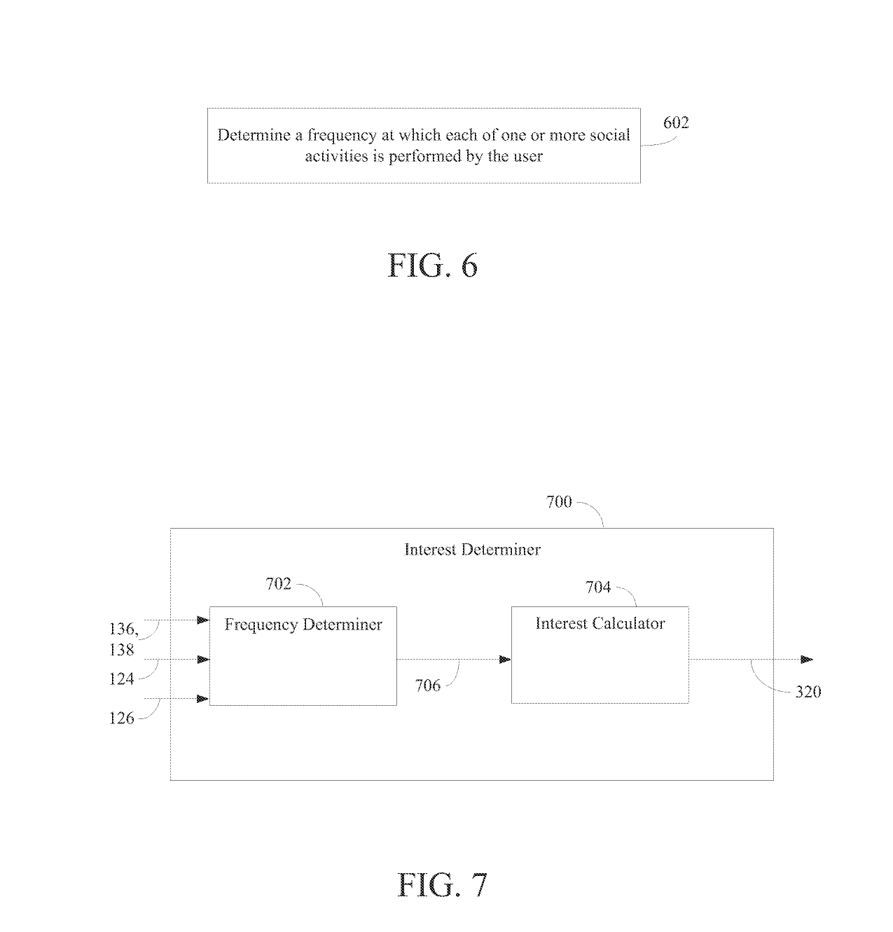

Measure of interest 320 may be represented in various ways, such as being represented by a numeric value, where a high numeric value indicates that the user is likely to be interested in topic 124, and a low numeric value indicates that the user is not likely to be interested in topic 124. Additional details concerning the structure, function, and operation of interest determiner 304 is provided below in reference to FIGS. 6-7.

In one embodiment, measure of influence 318 and measure of interest 320 are determined over a predetermined time period or range that is prior to when the offer(s) are to be presented to the user. In one embodiment, the predetermined time period is the most recent two weeks before offer(s) are to be presented to user(s). In this case, influence determiner 302 and interest determiner 304 may determine measure of influence 318 and measure of interest 320 based on indications 136 and 138 that were received during the most recent two weeks before offer(s) are to be presented to user(s). Any indications 136 and 138 received before the most recent two weeks are not considered when determining measure of influence 318 and measure of interest 320. This advantageously ensures that influence determiner 302 and interest determiner 304 are considering the most recent social activity performed by the user and other user(s) that have a social connection with the user.

It is noted that other predetermined time periods may alternatively be used (e.g., a prior hour, a prior week, a prior month, a prior year, etc.). In certain embodiments, the predetermined time period is exposed as a configurable parameter to a system administrator (e.g., a vendor, merchant, seller, etc.), thereby allowing the parameter to be tuned to achieve desired performance. For example, as shown in FIG. 3, time determiner 310 receives predetermined time period 314 as a configurable parameter defined by a system administrator and forwards predetermined time period 314 to influence determiner 302 and interest determiner 304. Thereafter, influence determiner 302 and interest determiner 304 determine measure of influence 318 and measure of interest 320 based on indications 136 and 138 received during predetermined time period 314.

Referring back to FIG. 2, in step 206, for each of a plurality of topics, a measure of conversion of the user for the topic is determined based on the measure of influence and the measure of conversion. For example, in an embodiment, conversion determiner 306 receives user identifier 126, topic 124, measure of influence 318 and measure of interest 320. User identifier 126 and topic 124 respectively identify the user and topic for which the measure of conversion is being determined Conversion determiner 306 may determine measure of conversion 122 for the user (as identified via user identifier 126) based on measure of influence 318 and measure of interest 320 and transmits measure of conversion 122 to threshold determiner 308.

For instance, in an embodiment, measure of conversion 122 may be represented for the identified user as follows:

measure of conversion 122=z(measure of influence 318,measure of interest 320,time period 314)

where

h=a measure of conversion function.

As such, measure of conversion 122 indicates a potential of conversion for the identified user in a particular topic (associated with the value used for measure of interest 320).

Measure of conversion 122 may be represented in various ways, such as being represented by a numeric value, where a high numeric value indicates that the user has a high probability of purchasing the offer associated with topic 124, and a low numeric value indicates that the user has a low probability of purchasing the offer associated with topic 124.

In embodiments, conversion determiner 306 may generate measure of conversion 122 based on measure of influence 318 and measure of interest 320 in various ways, including according to various formulas and/or algorithms, by setting relative weightings of measure of influence 318 and measure of interest 320 in any manner, etc. For instance, in an embodiment, measure of conversion 122 may be determined by taking the average of measure of influence 318 and measure of interest 320. For example, conversion determiner 306 may determine that for the topic “television sets,” the determined measure of influence 318 for a User A is 58 (on a scale of 1 to 100) and the determined measure of interest 320 for User A is 94 (on a scale of 1 to 100). In this example, measure of conversion 122 would be 76 ((58+94)/2). Seventy-six is a relatively high numeric value on a scale of 1 to 100. Therefore, conversion determiner 306 may determine that the probability that User A is likely to purchase an item associated with the topic “television sets” is high.

The measure of conversion determination described above with respect to the determined measure of influence and the determined measure of influence is one example technique and is not intended to be limiting. For instance, measure of influence 318 and measure of interest 320 may be scaled and added, may be multiplied together, etc. Other techniques for determining measure of conversion 122 are within the scope of the example embodiments, and may become apparent to persons skilled in the relevant art(s) from the teachings provided herein.

Referring back to FIG. 2, in step 208, a determination is made whether the measure of conversion for one of the plurality of topics reaches a predetermined threshold. For example, in an embodiment, threshold determiner 308 receives user identifier 126, topic 124, and measure of conversion 122. User identifier 126 and topic 124 respectively identify the user and topic associated with measure of conversion 122. Threshold determiner 308 determines whether measure of conversion 122 reaches (e.g., is greater than or equal to) the predetermined threshold. If threshold determiner 308 determines that measure of conversion 122 reaches the predetermined threshold, threshold determiner 308 transmits a conversion indication 326 to offer provider 312. Conversion indication 326 may indicate that measure of conversion 122 reached the predetermined threshold. If threshold determiner 308 determines that measure of conversion 122 does not reach the predetermined threshold, threshold determiner 308 does not transmit conversion indication 122 to offer provider 312, or may provide conversion indication 122 with a value indicating the predetermined threshold was not reached.

In an embodiment, the predetermined threshold is exposed as a configurable parameter to a system administrator (e.g., a vendor, merchant, seller, etc.), thereby allowing the parameter to be tuned to achieve desired performance. Furthermore, threshold determiner 308 may be configured to determine whether measure of conversion 122 matches further or alternative criteria, such determining whether measure of conversion 122 has a value within one or more predetermined ranges of values, etc. If measure of conversion 122 matches the further or alternative criteria, threshold determiner 308 may generate conversion indication 326 to indicate such a match.

Referring back to FIG. 2, in step 210, one or more offers associated with the topic is presented to the user in response to determining that the measure of conversion reaches the predetermined threshold. For example, in an embodiment, offer provider 312 receives user identifier 126, topic 124, and indicator 326. User identifier 126 identifies the user to whom an offer is to be provided, and topic 124 indicates the topic of the offer that is to be provided to the user. Offer provider 312 may provide offer 134 for an item 116 associated with topic 124 to the user (as identified via user identifier 126) in response to receiving conversion indication 326 indicating that the predetermined threshold was reached and/or other criteria was matched.

A. Example Influence Determiner and Method

In embodiments, influence determiner 302 of FIG. 3 may operate in various ways to determine measure of influence 318. For instance, FIG. 4 shows a flowchart 400 providing a process for determining a measure of influence that social activity has on a user for a topic, according to an example embodiment. In an embodiment, influence determiner 302 may operate according to flowchart 400. Furthermore, FIG. 5 shows a block diagram of an influence determiner 500, according to an example embodiment. Influence determiner 500 is an example of influence determiner 302. As shown in FIG. 4, influence determiner 500 includes an activity determiner 502, an interaction determiner 504, and an influence calculator 506. Flowchart 400 is described with respect to influence determiner 500 for illustrative purposes. Further structural and operational embodiments will be apparent to persons skilled in the relevant art(s) based on the following description of flowchart 400 and influence determiner 500.

Flowchart 400 begins with step 402. In step 402, for each of a plurality of topics, one or more social activities associated with the topic that are performed by other user(s) that have a social connection with the user are determined. For example, as shown in FIG. 5, in an embodiment, activity determiner 502 receives user identifier 126, topic 124, and indications 136 and 138. Based on indications 136 and 138 (and potentially further indications), activity determiner 502 is configured to determine one or more activities for the identified user that are associated with topic 124, and performed by other users. For instance, activity determiner 502 may extract activities identified in indications 136, 138, and further social activity indications that identify the user. Such activities may be identified by an alphanumeric name (e.g., “text message”, “blog post,”), by a numerical identifier associated with the activity, or in other ways.

In an embodiment, activity determiner 502 includes a weight associator 508 that associates each of the social activities determined by activity determiner 502 with a respective weighting factor. For each social activity determined, weight associator 508 may associate the respective weighting factor based on the type of social activity. For example, weight associator 508 may associate a greater weighting factor to a first type of social activity and associate a lower weighting factor to a second type of social activity. Social activity associated with a greater weighting factor may count towards a measure of influence determination more than social activity associated with a lesser weighting factor.

For instance, in one example embodiment, e-mails and IM text messages are associated with the greatest weighting factor, social networking posts and microblog posts are assigned the next to lowest weighting factor, and “liking” a social networking post is assigned the lowest weighting factor. In another embodiment, each such message, post, and/or “like” indication may have other relative weightings.

It is noted that the weight association technique described above is one example technique and is not intended to be limiting. Other techniques for determining associating weights with social activities are within the scope of the example embodiments. In certain embodiments, the weighting factors are exposed as configurable parameters to a system administrator (e.g., a vendor, merchant, seller, etc.), thereby allowing the system administrator to designate which types of social activity are to be associated with the greatest weighting factor, which types of social activity are to be associated with the lowest weighting factor, etc.

Once the social activit(ies) are determined, activity determiner 502 generates an activity indicator 522, which indicates the social activit(ies) determined to have been performed by the other user(s) that have a social connection with the user.

In step 404, a level of interaction that the user has with the other user(s) that have a social connection with the user is determined. For instance, as shown in FIG. 5, interaction determiner 504 receives activity indicator 522, indications 136 and 138, and user identifier 126. Interaction determiner 502 is configured to determine a level of interaction 520 that the user identified by user identifier 126 has with other users based on activity indicator 522 and indications 136 and 138. In embodiments, interaction determiner 502 may generate level of interaction 520 based on an amount (e.g., a number) of social activities undertaken by the user with other users and/or based on a type of social activities undertaken by the user.

For example, in an embodiment, interaction determiner 504 may include social activity measurer 510 and interaction calculator 514. Social activity measurer 510 may measure the amount of social activity (as indicated via indications 136 and 138, etc.) that the user has with another user and transmit an amount indicator 516 to interaction calculator 514 that identifies an amount of social activity events (e.g., a number of social interactions). For instance, amount indicator 516 may indicate the amount of indications 136, 138, etc. received by social activity measurer 510. For example, suppose that four interactions received by social activity measurer 510 are social networking posts between the user and the other user, three interactions received by social activity measurer 510 are IM text messages between the user and the other user, two interactions received by social activity measurer 510 are microblog posts between the user and the other user, and one interaction received by social activity measurer 510 is a “like” indication performed by the user on a social network posting made by the other user. In this example, because a total of ten interactions were received by social activity measurer 510, social activity measurer 510 would generate amount indicator 516 equal to ten.

As shown in FIG. 5, interaction calculator 514 receives amount indicator 516. Interaction calculator 514 determines level of interaction 520 based on amount indicator 516 and transmits level of interaction 520 to influence calculator 506. For instance, interaction calculator 514 may convert a numerical value provided in amount indicator 516 to a factor in a predetermined range that indicates a normalized relative interaction level (a value between 0 and 1, between 1 and 100, etc.). As such, in an embodiment, level of interaction 520 may be represented as a numeric value, where a high numeric value indicates that the level of interaction between the user and the other user is relatively high, and a low numeric value indicates the level of interaction between the user and the other user is relatively low. Level of interaction 520 may be a function of amount indicator 516. Accordingly, if amount indicator 516 is a relatively high value, level of interaction 520 will be a relatively high numeric value. In contrast, if amount indicator 516 is a relatively low value, level of interaction 520 will be a relatively low numeric value.

In another embodiment, level of interaction 520 between the user and other user(s) may be generated based on the type of activity that the user has with other user(s). For example, in an embodiment, interaction determiner 502 includes social activity classifier 512. Social activity classifier 512 may determine a type of social activity that the user has with another user that occurs more than any other type of social activity that the user has with the other user. In an embodiment, social activity classifier 512 may rank the social activities engaged in by the users from most frequent to least frequent. Social activity classifier 512 may generate a type indicator 518 that indicates the type of social activity that occurred the most often, and/or includes other social activity type data.

In such an embodiment, interaction calculator 514 may determine level of interaction 520 based on type indicator 518, and level of interaction 520 is received by influence calculator 506. In an embodiment, different types of activities may have corresponding predetermined rankings of importance, which result in level of interaction 520 having different values depending on activity type. For instance, if the type of social activity that occurred the most between the user and the other user were e-mails and/or IM text messages, interaction calculator 514 may set level of interaction 520 to a relatively high value. If the type of social activity that occurred the most between the user and the other user were social networking posts and/or microblog posts, interaction calculator 514 may set level of interaction 520 to a relatively moderate value. If the type of social activity that occurred the most between the user and the other user were “like” indications, interaction calculator 514 may set level of interaction 520 to a relatively low value.

As such, in embodiments, interaction calculator 514 may generate level of interaction 520 to be based on an amount of social activity (amount indicator 516) and/or on a type of social activity (type indicator 518).

Influence calculator 506 receives user identifier 126, topic 124, activity indicator 522, and level of interaction 520. Influence calculator 506 is configured to determine a measure of influence 318 for the identified user and topic 124 based on the determined social activities (as indicated via activity indicator 522) and the determined level of interaction (as indicated via level of interaction 520). For example, in an embodiment, level of interaction 520 may be used as a weighting factor that is applied to activity indicator 522 to generate measure of influence 318. In this example, activities that are performed by users having a higher level of interaction are factored into determining measure of influence 318 more than activities that are performed by users having a lower level of interaction. In other embodiments, activity indicator 522 and level of interaction 520 may be combined in other ways to generate measure of influence 318.

B. Example Interest Determiner and Method

In embodiments, interest determiner 304 (as depicted in FIG. 3) may operate in various ways to determine measure of interest 320. For instance, FIG. 6 shows a step 602 providing a process for determining a measure of interest of a user for a topic, according to an example embodiment. In an embodiment, interest determiner 304 may operate according to step 602. Furthermore, FIG. 7 shows a block diagram of interest determiner 700, according to an example embodiment. Interest determiner 700 is an example of interest determiner 304. As shown in FIG. 7, interest determiner 700 includes a frequency determiner 702 and an interest calculator 704. Step 602 is described with respect to interest determiner 700 for illustrative purposes. Further structural and operational embodiments will be apparent to persons skilled in the relevant art(s) based on the following description of step 602 and influence determiner 700.

In step 602, a frequency at which each of one or more social activities is performed by the user is determined. For example, frequency determiner 702 receives user identifier 126, topic 124, and indications 136 and 138. Frequency determiner 702 is configured to determine a frequency at which social activity that is associated with topic 124 is performed by the identified user, based on indications 136, 138, and potentially further social activity indications.

For example, frequency determiner 702 may determine the amount of social activity that the user has performed with respect to topic 124. After determining the amount, frequency determiner 702 may transmit a frequency indicator 706 to interest calculator 704. Frequency indicator 706 may indicate the amount of indications 136, 138, and any further indications received by frequency determiner 702. For example, suppose five interactions are received by frequency determiner 702 that are social networking posts made by the user with regard to topic 124, four interactions are received by frequency determiner 702 that are IM text messages made by user with regard to topic 124, three interactions are received by frequency determiner 702 that are microblog posts made by user with regard to topic 124, and two interactions are received by frequency determiner 702 that are “like” indications performed by the user on a social network posting made by another other user with regard to topic 124. In this example, because a total of fourteen interactions were received by frequency determiner 702, frequency determiner 702 may generate frequency indicator 706 to be equal to fourteen.

As shown in FIG. 7, interest calculator 704 receives frequency indicator 706. Interest calculator 704 is configured to determine measure of interest 320 based on frequency indicator 706. For instance, interest calculator 704 may convert a numerical value provided in frequency indicator 706 to a factor in a predetermined range that indicates a normalized relative interest level (a value between 0 and 1, between 1 and 100, etc.). In an embodiment, measure of interest 320 may be represented as a numeric value, where a high numeric value indicates that the measure of interest that the user has with respect to a topic is relatively high, and a low numeric value indicates the measure of interest that the user has with respect to a topic is relatively low. In an embodiment, measure of interest 320 may be proportional to frequency indicator 706, such that if frequency indicator 706 is a relatively high value, measure of interest 320 is generated as a relatively high numeric value. In contrast, if frequency indicator 7065 is a relatively low value, measure of interest 320 is generated to be a relatively low numeric value.

Accordingly, in an embodiment, conversion determiner 306 of FIG. 3 may receive measure of influence 318 generated by influence determiner 500 of FIGS. 5 and measure of interest 320 generated by interest determiner 700 of FIG. 7, and generate measure of conversion 122 based thereon.

### II. Example Computer Implementations

Deal conversion system 110, deal conversion system 300, influence determiner 302, interest determiner 304, conversion determiner 306, threshold determiner 308, time determiner 310, offer provider 312, influence determiner 500, activity determiner 502, interaction determiner 504, influence calculator 506, weight associator 508, social activity measurer 510, social activity classifier 512, interaction calculator 514, interest determiner 700, frequency determiner 702, interest calculator 704, flowchart 200, flowchart 400, step 602, and/or any further systems, sub-systems, and/or components disclosed herein may be implemented in hardware, or any combination of hardware with software and/or firmware. For example, deal conversion system 110, deal conversion system 300, influence determiner 302, interest determiner 304, conversion determiner 306, threshold determiner 308, time determiner 310, offer provider 312, influence determiner 500, activity determiner 502, interaction determiner 504, influence calculator 506, weight associator 508, social activity measurer 510, social activity classifier 512, interaction calculator 514, interest determiner 700, frequency determiner 702, interest calculator 704, flowchart 200, flowchart 400, and/or step 602 may be implemented as computer program code configured to be executed in one or more processors. Alternatively, deal conversion system 110, deal conversion system 300, influence determiner 302, interest determiner 304, conversion determiner 306, threshold determiner 308, time determiner 310, offer provider 312, influence determiner 500, activity determiner 502, interaction determiner 504, influence calculator 506, weight associator 508, social activity measurer 510, social activity classifier 512, interaction calculator 514, interest determiner 700, frequency determiner 702, interest calculator 704, flowchart 200, flowchart 400, and/or step 602, may be implemented as hardware logic/electrical circuitry.

As described above, deal conversion systems may generate one or more user interfaces. For instance, deal conversion systems may enable user input to be provided from one or more of any type of user interface elements provided by a computing device, including a keyboard, a thumb wheel, a pointing device, a roller ball, a stick pointer, a touch sensitive display, any number of virtual interface elements, a voice recognition system, etc. Graphical user interfaces (GUI) may be displayed in a display of the computing device, such as in a browser window generated by a web browser, an application window, or in other window type mentioned elsewhere herein or otherwise known.

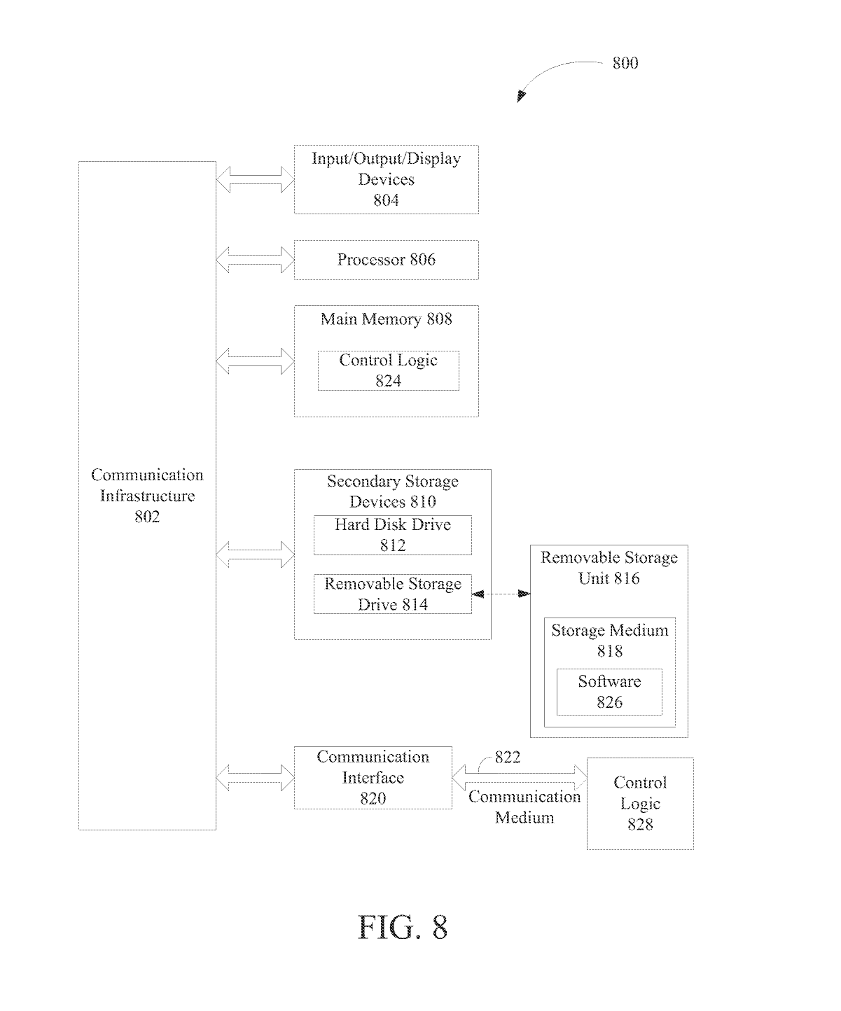

The embodiments described herein, including systems, methods/processes, and/or apparatuses, may be implemented using well known servers/computers, such as a computer 800 shown in FIG. 8. For example, user devices 102 and 104, server 106, and any of the sub-systems or components contained therein may be implemented using one or more computers 800.

Computer 800 can be any commercially available and well known computer capable of performing the functions described herein, such as computers available from International Business Machines, Apple, Sun, HP, Dell, Cray, etc. Computer 800 may be any type of computer, including a desktop computer, a server, etc.

Computer 800 includes one or more processors (also called central processing units, or CPUs), such as a processor 806. Processor 806 is connected to a communication infrastructure 802, such as a communication bus. In some embodiments, processor 806 can simultaneously operate multiple computing threads.

Computer 800 also includes a primary or main memory 808, such as random access memory (RAM). Main memory 808 has stored therein control logic 824 (computer software), and data.

Computer 800 also includes one or more secondary storage devices 810. Secondary storage devices 810 include, for example, a hard disk drive 812 and/or a removable storage device or drive 814, as well as other types of storage devices, such as memory cards and memory sticks. For instance, computer 800 may include an industry standard interface, such a universal serial bus (USB) interface for interfacing with devices such as a memory stick. Removable storage drive 814 represents a floppy disk drive, a magnetic tape drive, a compact disk drive, an optical storage device, tape backup, etc.

Removable storage drive 814 interacts with a removable storage unit 816. Removable storage unit 816 includes a computer useable or readable storage medium 818 having stored therein computer software 826 (control logic) and/or data. Removable storage unit 816 represents a floppy disk, magnetic tape, compact disk, DVD, optical storage disk, or any other computer data storage device. Removable storage drive 814 reads from and/or writes to removable storage unit 816 in a well-known manner.

Computer 800 also includes input/output/display devices 804, such as monitors, keyboards, pointing devices, etc.

Computer 800 further includes a communication or network interface 1418. Communication interface 820 enables computer 800 to communicate with remote devices. For example, communication interface 820 allows computer 800 to communicate over communication networks or mediums 822 (representing a form of a computer useable or readable medium), such as LANs, WANs, the Internet, etc. Network interface 820 may interface with remote sites or networks via wired or wireless connections.

Control logic 828 may be transmitted to and from computer 800 via the communication medium 822.

Any apparatus or manufacture comprising a computer useable or readable medium having control logic (software) stored therein is referred to herein as a computer program product or program storage device. This includes, but is not limited to, computer 800, main memory 808, secondary storage devices 810, and removable storage unit 816. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing deal conversion system 110, deal conversion system 300, influence determiner 302, interest determiner 304, conversion determiner 306, threshold determiner 308, time determiner 310, offer provider 312, influence determiner 500, activity determiner 502, interaction determiner 504, influence calculator 506, weight associator 508, social activity measurer 510, social activity classifier 512, interaction calculator 514, interest determiner 700, frequency determiner 702, interest calculator 704, flowchart 200, flowchart 400, step 602, (including any step of flowcharts 200 and 400), and/or further embodiments described herein. Embodiments of the invention are directed to computer program products comprising such logic (e.g., in the form of program code, instructions, or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for presenting one or more offers to a user, comprising:
for each of a plurality of topics:
determining a measure of influence that social activity has on a user for the topic,
determining a measure of interest of the user for the topic, and
determining a measure of conversion of the user for the topic, wherein the measure of conversion is indicative of a probability that the user will purchase an offer associated with the topic, wherein the measure of conversion is based on the measure of influence and the measure of interest; and
for one of the plurality of topics:
determining whether the measure of conversion reaches a predetermined threshold; and
presenting one or more offers associated with the topic in response to determining that the measure of conversion reaches the predetermined threshold.

2. The method of claim 1, wherein determining the measure of influence for each topic comprises:
determining one or more social activities that are performed by one or more other users that have a social connection with the user, wherein the one or more social activities are associated with the topic; and
determining a level of interaction that the user has with the one or more other users, wherein the measure of influence is based on the one or more social activities and the level of interaction.

3. The method of claim 2, wherein determining the one or more social activities comprises:
associating each of the one or more social activities with a respective weighting factor, wherein the measure of influence is further based on the respective weighting factor of each of the one or more social activities.

4. The method of claim 2, wherein determining the level of interaction that the user has with the one or more other users comprises:
determining an amount of social activity that the user has with the one or more other users,
wherein the level of interaction is based on the amount of social activity.

5. The method of claim 2, wherein determining the level of interaction that the user has with the one or more other users comprises:
determining a type of social activity that the user has with the one or more other users that occurs more than any other type of social activity that the user has with the one or more other users,
wherein the level of interaction is based on the type of social activity.

6. The method of claim 1, wherein determining the measure of interest of the user for each topic comprises:
determining a frequency at which each of one or more social activities is performed by the user, wherein each of the one or more social activities are associated with the topic,
wherein the measure of interest of the user for each topic is based on the frequency.

7. The method of claim 1, wherein the measure of influence and the measure of interest are determined over a predetermined time period that is prior to when the one or more offers are to be presented to the user.

8. A system for presenting one or more offers to a user, comprising:
an influence determiner configured to, for each of a plurality of topics, determine a measure of influence that social activity has on a user for the topic;
an interest determiner configured to, for each of the plurality of topics, determine a measure of interest of the user for the topic;
a conversion determiner configured to, for each of the plurality of topics, determine a measure of conversion of the user for the topic, wherein the measure of conversion is indicative of a probability that the user will purchase an offer associated with the topic, wherein the measure of conversion is based on the measure of influence and the measure of interest;
a threshold determiner configured to, for one of the plurality of topics, determine whether the measure of conversion reaches a predetermined threshold; and
an offer provider configured to, for at least one of the plurality of topics, present one or more offers associated with the topic in response to a determination that the measure of conversion reaches the predetermined threshold.

9. The system of claim 8, wherein the influence determiner comprises:
an activity determiner that determines one or more social activities associated with each topic that are performed by one or more other users that have a social connection with the user;
an interaction determiner that determines a level of interaction that the user has with the one or more other users; and
an influence calculator that determines the measure of influence for a topic based on the determined one or more social activities for the topic and the determined level of interaction.

10. The system of claim 9, wherein the activity determiner comprises:
a weight associator that associates each of the one or more social activities with a respective weighting factor, wherein the influence calculator determines the measure of influence based on the determined one or more social activities for the topic, the determined level of interaction, and the respective weighting factor of each of the one or more social activities.

11. The system of claim 9, wherein the interaction determiner comprises:
a social activity measurer that measures an amount of social activity that the user has with the one or more other users; and
an interaction calculator that determines the level of interaction that the user has with the one or more other users based on the amount of social activity that the user has with the one or more other users.

12. The system of claim 9, wherein the interaction determiner comprises:
a social activity classifier that determines a type of social activity that the user has with the one or more other users that occurs more than any other type of social activity that the user has with the one or more other users; and
an interaction calculator that determines the level of interaction that the user has with the one or more other users based on the type of social activity that the user has with the one or more other users that occurs more than any other type of social activity that the user has with the one or more other users.

13. The system of claim 8, wherein the interest determiner comprises:
a frequency determiner that determines a frequency at which each of one or more social activities that are associated with the topic is performed by the user; and
an interest calculator that determines the measure of interest of the user for each topic based on the determined frequency

14. The system of claim 8, further comprising:
a time determiner that determines a predetermined time period that is prior to when the one or more offers are to be presented to the user;
wherein the influence determiner determines the measure of influence and the interest determiner determines the measure of interest over the predetermined time period.

15. A computer program product comprising a computer readable medium having computer readable program code embodied in said medium for enabling a processing unit to present one or more offers to a user, the computer readable program code comprising:
first computer readable program code that enables the processing unit to, for each of a plurality of topics, determine a measure of influence that social activity has on a user for the topic;
second computer readable program code that enables the processing unit to, for each of the plurality of topics, determine a measure of interest of the user for the topic;
third computer readable program code that enables the processing unit to, for each of the plurality of topics, determine a measure of conversion of the user for the topic, wherein the measure of conversion is indicative of a probability that the user will purchase an offer associated with the topic, wherein the measure of conversion is based on the measure of influence and the measure of interest;
fourth computer readable program code that enables the processing unit to, for at least one of the plurality of topics, determine whether the measure of conversion reaches a predetermined threshold; and
fifth computer readable program code that enables the processing unit to, for one of the plurality of topics, present one or more offers associated with the topic in response to a determination that the measure of conversion reaches the predetermined threshold.

16. The computer program product of claim 15, wherein the first computer readable program code comprises:
sixth computer readable program code that enables the processing unit to determine one or more social activities associated with each topic that are performed by one or more other users that have a social connection with the user;
seventh computer readable program code that enables the processing unit to determine a level of interaction that the user has with the one or more other users; and
eighth computer readable program code that enables the processing unit to determine the measure of influence for a topic based on the determined one or more social activities for the topic and the determined level of interaction.

17. The computer program product of claim 16, wherein the seventh computer readable program code comprises:
ninth computer readable program code that enables the processing unit to associate each of the one or more social activities with a respective weighting factor, wherein the first computer readable program code enables the processing unit to determine the measure of influence based on one or more social activities for the topic, the determined level of interaction, and the respective weighting factor of each of the one or more social activities.

18. The computer program product of claim 16, wherein the seventh computer readable program code comprises:
ninth computer readable program code that enables the processing unit to measure an amount of social activity that the user has with the one or more other users; and
tenth computer readable program code that enables the processing unit to determine the level of interaction that the user has with the one or more other users based on the amount of social activity that the user has with the one or more other users.

19. The computer program product of claim 16, wherein the seventh computer readable program code comprises:
ninth computer readable program code that enables the processing unit to determine a type of social activity that the user has with the one or more other users that occurs more than any other type of social activity that the user has with the one or more other users; and
tenth computer readable program code that enables the processing unit to determine the level of interaction that the user has with the one or more other users based on the type of social activity that the user has with the one or more other users that occurs more than any other type of social activity that the user has with the one or more other users.

20. The computer program product of claim 15, wherein the second computer readable program mode comprises:
sixth computer readable program code that enables the processing unit to determine a frequency at which each of one or more social activities that are associated with the topic is performed by the user; and
seventh computer readable program code that enables the processing unit to determine the measure of interest of the user for each topic based on the determined frequency.
